(19) United States
(12) Patent Application Publication
(10) Pub. No.: US 2010/0310518 A1
(43) Pub. Date: Dec. 9, 2010

(54) Combinations of Flubendiamide and Beneficial Species

(75) Inventors: Heike Hungenberg, Langenfeld (DE); Hans-Jürgen Schnorbach, Monheim (DE); Wolfram Andersch, Bergisch Gladbach (DE); Udo Reckmann, Koln (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 12/793,078

(22) Filed: Jun. 3, 2010

(30) Foreign Application Priority Data
Jun. 3, 2009 (DE) 102009026699.2

(51) Int. Cl. A01N 63/00; A01N 63/04; A01N 65/00; A01P 7/04; A01P 7/02

(52) U.S. Cl. 424/93.3; 424/93.5; 424/93.4; 424/93.6; 424/538; 424/520

(57) ABSTRACT

The novel combinations of flubendiamide and beneficial species comprising flubendiamide and at least one beneficial species from the orders or suborders of the Araneae, Acari, Dermaptera, Hymenoptera, Coleoptera, Neuroptera, Thysanoptera, Heteroptera, Diptera, Hemiptera, Dermaptera and/or Parasitiformes or at least one bacteria strain or at least one virus strain for the effective control of unwanted pests.

The present invention relates to combinations of flubendiamide and beneficial species comprising 3-iodo-N′-(2-mesyl-1,1-dimethylethyl)-N-{4-[1,2,2,2-tetrafluoro-1-(trifluoromethyl)ethyl]-o-tolyl}phthalamide, known as flubendiamide, and at least one type of beneficial species for the effective and environmentally friendly control of animal pests such as insects and/or unwanted acarids.

The insecticidal and acaricidal action of 3-iodo-N′-(2-mesyl-1,1-dimethylethyl)-N-{4-[1,2,2,2-tetrafluoro-1-(trifluoromethyl)ethyl]-o-tolyl}phthalamide (flubendiamide) and also its suitability as pest control agent have been known for a long time and were described for the first time in EP-A-1 006 107. It is also known that the activity of flubendiamide can be increased by combining it with other chemicals such as, for example, insecticides. Thus, for example, EP-A-1 380 209 and WO 2004/034786 describe the enhanced activity of combinations comprising flubendiamide and other insecticides. An increased insecticidal and acaricidal activity of flubendiamide by addition of ammonium or phosphonium salts has also been described (WO 2007/068357).

The use of beneficial species for controlling pests is generally known (for example from “Knowing and recognizing”; M. H. Malais, W. J. Ravensberg, published by Koppert B. V., Reed Business Information (2003)). Beneficial species are in most cases arachnids or insects which are in some way or other useful for man, in particular by relying on other insects, for their part referred to as pests, as food or as a host. However, the term “beneficial species” is not limited to arachnids and insects. In the present invention, it also includes fungi or bacteria or virus strains suitable for controlling pests. Beneficial species are particularly suitable for controlling pests in greenhouses. The use of beneficial species has the advantage that no resistencies are developed and that there are no waiting times for cultivation and care measures and for harvesting. Moreover, by employing beneficial species, the user is not exposed to crop protection agents.

For pest control, a sufficient quantity of beneficial species is released or inoculated at the site of action (for example in a greenhouse). In general, the beneficial species are only employed in case of an attack by pests (curative). Since beneficial species are the natural enemies of the pests to be controlled, their activity spectrum is frequently limited to the specific pest and in some cases even to specific development stages of these pests. However, since a plurality of pest species having different control requirements, such as, for example, time of application, beneficial species and beneficial species climate, may occur in a crop, the crop has to be monitored regularly and requires a rapid reaction in the case of an attack. Moreover, the user has to have in-depth knowledge of the crop, the pests and the beneficial species.

If the attack by pests is noticed too late and as a result the pest population has grown too much, beneficial species alone are not sufficient to control the pests, and a combined use of the beneficial species with chemical pesticides is required.

It has now been found that a combination of flubendiamide and beneficial species avoids the disadvantages mentioned above and is additionally highly effective.

The beneficial species that can be used in the combination according to the invention are microorganisms such as fungi (for example Metarhizium anisopliae or Beauveria bassiana) or bacteria or virus strains (for example Bacillus strains or baculoviruses such as granulosis viruses) and also insects and arachnids from the orders or suborders of the Araneae, Acari, Dermaptera, Hymenoptera, Coleoptera, Neuroptera, Thysanoptera, Heteroptera, Diptera, Hemiptera, Dermaptera and/or Parasitiformes, Plannipennia, particularly preferably from the families of the Vespidae, Aphelinidae, Trichogrammatidae, Encyrtidae, Mymaridae, Eulophidae, Alloxystidae, Megaspilidae, Braconidae, Cantharidae, Coccinellidae, Cleridae, Chrysopidae, Hemerobiidae, Anthocoridae, Miridae, Forficulidae, Phytoseiidae, Carabidae, Staphylenidae, Ichneumonidae, Bracconidae, Aphidiidae, Eumenidae, Sphecidae, Tachnidae, Syrphidae, Cecidomyiidae, Stigmaeidae, Angstidae, Trombidiidae, Nabidae, Pentatomidae, Reduviidae, Coniopterygidae, Chameiidae, Asilidae and Euzetidae (soil mites). Furthermore predatory mites and nematodes.

Preference is given to combinations of flubendiamide and beneficial species comprising flubendiamide and at least one beneficial species selected from the insects and arachnids from groups (1) to (7):

(1) predatory mites from the order Amblyseius spp., such as, for example, Amblyseius barkeri and Amblyseius cucumeris, and also from the order Hypoaspis spp., such as, for example, Hypoaspis miles, Hypoaspis aculeifer and from the order Phytoseiulus spp., such as, for example, Phytoseiulus persimilis;
(2) nematodes from the order Steinernema spp., such as, for example, Steinernema feltiae and Steinernema carpocapsae, and from the order Heterorhabditis spp., such as, for example, Heterorhabditis bacteriophora;
(3) bugs (Heteroptera) from the orders Anthocoris spp. (flower bugs), such as, for example, Anthocoris nemorum, Orius spp. such as, for example, Orius majusculus, and Macrolophus spp. (predatory bugs), such as, for example, Macrolophus caliginosus and Macrolophus pygmaeus;
(4) lacewings (Plannipennia) from the orders Chrysoperla spp. such as, for example, Chrysoperla carnea (common green lacewing) and Chrysopa perla (golden-eyes), and Hemerobius spp. such as, for example, Hemerobius humulinus (aphid lions);
(5) hymenopterans (Hymenoptera) from the orders Trichogramma spp., Aphidius spp. (ichneumon wasps), such as, for example, Aphidius colemani, A. Aphidius ervi., Lariophagus spp. (pteromalid wasp), such as, for example, Lariophagus distinguendus, Lysiphlebus spp., such as, for example, Lysiphlebus testaceipes, Encarsia spp. (ichneumon wasp), such as, for example, Encarsia formosa, Dacnusa spp., such as, for example, Dacnusa sibirica, Aphelinus spp., such as, for example, Aphelinus abdominalis, Diglyphus spp., such as, for example, Diglyphus isaea, Leptomastix spp., such as, for example, Leptomastix abnormis, Dabnusa spp., such as, for example, Dabnusa sibirica, Trichogramma spp. (ichneumon wasp), such as, for example, Trichogramma brassicae, Trichogramma dendrolimi and Trichogramma evanescens. pteromalid wasp Lariophagus distinguendus;
(6) beetles (Coleoptera) from the orders Coccinella spp., such as, for example, Coccinella septempunctata and Cryptolaemus spp., such as, for example, Cryptolaemus montrouzieri;
(7) Diptera from the orders Episyrphus spp., such as, for example, Episyrphus balteatus, Feltiella spp., such as, for example, Feltiella acarisuga, and Aphidoletes spp., such as, for example, Aphidoletes aphidimyza (predatory gall midge);
or selected from the following microorganisms: Bacillus thuringiensis, Bacillus firmus, Bacillus subtilis, Baculoviruses, Beauveria brongniartii and Beauveria bassiana, Metarhizium anisopliae, Metarhizium acridum and Thanasimus formicarius.

Preference is given to combinations of flubendiamide and beneficial species comprising flubendiamide and at least one beneficial species selected from the beneficial species mentioned in Table 1.

For the purpose of the present invention, combinations of flubendiamide and beneficial species also include those combinations where flubendiamide and the beneficial species are applied at different times and/or locations. Thus, flubendiamide can be used in the soil or in soil-less substrate and the beneficial species on the plant, or vice versa. Combinations according to the invention of flubendiamide and beneficial species are also present when the beneficial species is present on the plant even before the treatment, and the treatment with flubendiamide shifts the balance between pest and beneficial species in favour of the beneficial species.

Accordingly, the invention also relates to the use of flubendiamide in combination with beneficial species, preferably a beneficial species selected from one of groups (1) to (7), for controlling animal pests. Preferably, flubendiamide is used in combination with the beneficial species mentioned in Table 1 for controlling the animal pests mentioned in the same row.

TABLE 1

| No. | Beneficial species | Animal pest |
|---|---|---|
| 1-1 | Amblyseius barkeri | thrips, white mites, spider mites |
| 1-2 | Amblyseius cucumeris | thrips, white mites, spider mites |
| 1-3 | Anthocoris nemorum | spider mites, aphids, butterfly eggs, egg caterpillars and pollen |
| 1-4 | codling moth granulosis virus | Cydia pomonella |
| 1-5 | Bacillus thuringiensis | larvae of insects of the orders Coleoptera, Lepidoptera and |
| | | Diptera, in particular caterpillars of the green oak tortrix, the |
| | | mottled umber, the winter moth, the ermine moths, the brown- |
| | | tail, the large and the small white, the diamondback moth, the |
| | | green budworm moth, the eye-spotted budmoth, the lackey |
| | | moth, the gypsy moth, the vine moth and the Colorado beetle, |
| | | and also Autographa gamma |
| 1-6 | Baculovirus | potato moth Phthorimaea operculella and the Andean potato |
| | | weevil Premnotrypes spp |
| 1-7 | Beauveria bassiana or | European spruce bark beetle Ips typographus |
| | Metarhizium anisopliae | |
| 1-8 | Beauveria brongniartii | European cockchafer (Melolontha melolontha) |
| 1-9 | Chrysopa perla, Hemerobius | aphids |
| | humulinus, Aphidius colemani, A. Aphidius | |
| | ervi, Lysiphlebus | |
| | testaceipes or Aphidoletes | |
| | aphidimyza | |
| 1-10 | Chrysoperla carnea | aphids, scale insects und mealybugs, thrips, spider mites, |
| | | caterpillars |
| 1-11 | Encarsia formosa, Dacnusa | leaf-mining flies |
| | sibirica, Diglyphus isaea or | |
| | Dabnusa sibirica | |
| 1-12 | Episyrphus balteatus | aphids, also spider mites, woolly apple aphids, small |
| | | caterpillars, small insects |
| 1-13 | Heterorhabditis spp. | larvae of the garden chafer Phyllopertha horticola |
| 1-14 | Hypoaspis miles | larvae of dark-winged fungus gnats and Scatophila variegata, |
| | | pupae of thrips, springtails, the bulb mite Rizoglyphus robini |
| 1-15 | Hypoaspis aculeifer | larvae of dark-winged fungus gnats and Scatophila variegata, |
| | | pupae of thrips, springtails, the bulb mite Rizoglyphus robini |
| 1-16 | fungi pathogenic to insects | storage pests Sitophilus zeamais and Prostephanus truncatus |
| 1-17 | Leptomastix dactylop or | Planococcus citri |
| | Leptomastix abnormis | |
| 1-18 | Macrolophus caliginosus | greenhouse whitefly (Trialeurodes vaporariorum) and tobacco |
| | | whitefly (Bemisia tabaci). All stages, preferably eggs and |
| | | larvae, spider mites, butterfly eggs and thrips (also |
| | | Echinothrips americanus) aphids and larvae of leaf-mining |
| | | flies |
| 1-19 | Macrolophus caliginosus | whiteflies, aphids, spider mites |
| 1-20 | Macrolophus pygmaeus | whiteflies, aphids, spider mites |
| 1-21 | Metarhizium anisopliae var. | migratory locusts Locusta migratoria and Schistocerca |
| | acridum | gregaria |
| 1-22 | Orius majusculus | western flower thrips and pollen |
| 1-23 | Phytoseiulus persimilis or | spider mites |
| | Feltiella acarisuga | |
| 1-24 | Steinernema carpocapsae | larvae of soil- and leaf-dwelling insects of the Noctuidae |
| | | (owlet moths) family; larvae of Pyralidae (inter alia |
| | | Duponchelia fovealis); larvae of the large pine weevil |
| | | (Hylobius abietis); larvae of various pests of the orders |
| | | Coleoptera and Orthoptera (for example European mole |
| | | cricket) |
| 1-25 | Steinernema feltiae | cherry fruit fly (Rhagoletis cerasi), black vine weevil |
| | | (Otiorrhynchus sulcatus), dark-winged fungus gnats, western |
| | | flower thrips (Frankliniella occidentalis) |
| 1-26 | Thanasimus formicarius | bark beetles |
| 1-27 | Trichogramma brassicae | eggs of various butterfly species such as Mamestra, |
| | | Laconobia, Chrysodeixis and Autographa, and also the |
| | | European corn borer |
| 1-28 | Trichogramma dendrolimi | eggs of the codling moth |
| 1-29 | Trichogramma cacoeciae | eggs of the codling moth |
| 1-30 | Trichogramma evanescens | caterpillars of cabbage butterflies |
| I-31 | Trichogramma spp. | lepidoptera, the Indian meal moth Plodia interpunctella and |
| | | the clothing moth Tineola bisselliella |

The combinations of flubendiamide and beneficial species can be used in annual or perennial crops.

Annual crops are, for example: vegetables such as fruit vegetables and flower-heads/curds (for example bell peppers, chilli peppers, tomatoes, aubergines, cucumbers, cucurbits, courgettes, broad beans, runner beans, bush beans, peas, artichokes), leafy vegetables (for example lettuce, chicory, endives, cress, rocket salad, field salad, iceberg lettuce, leek, spinach, Swiss chard), tuber vegetables, root vegetables and stem vegetables (for example celeriac, beetroot, carrots, garden radish, horseradish, scorzonera, asparagus, table beet, palm shoots, bamboo shoots, moreover bulb vegetables, for example onions, leek, fennel, garlic), brassica vegetables (for example cauliflowers, broccoli, kohlrabi, red cabbage, white cabbage, green cabbage, Savoy cabbage, Brussels sprouts, Chinese cabbage), ornaments, such as cut flowers (for example roses, carnations, gerbera, lilies, marguerites, chrysanthemums, tulips, daffodils, anemones, poppies, amaryllis, dahlias, azaleas, malves, sunflowers), bedding plants, potted plants and shrubs (for example tagetes, pansies, busy lizzies, begonias), melons and maize.

Perennial crops are, for example, citrus fruit (for example oranges, grapefruit, mandarins, lemons, limes, bitter oranges, cumquats, satsumas), pome fruit (for example apples, pears and quince), stone fruit (for example peaches, nectarines, cherries, plums, common plums, apricots), grapevines, hops, olives, tea and tropical crops, such as, for example, mangoes, papayas, figs, pineapples, dates, bananas, durians, kakis, coconuts, cacao, coffee, avocados, litchis, maracujas, guavas, almonds and nuts, such as, for example, hazelnuts, walnuts, pistachios, cashew nuts, brazil nuts, pecan nuts, butter nuts, chestnuts, hickory nuts, macadamia nuts, peanuts, soft fruit (for example blackcurrants, gooseberries, raspberries, blackberries, blueberries, strawberries, red bilberries, kiwis, cranberries), ornaments, such as cut flowers (for example roses, carnations, gerbera, lilies, marguerites, chrysanthemums, tulips, daffodils, anemones, poppies, amaryllis, dahlias, azaleas, malves), bedding plants, potted plants and shrubs (for example roses, tagetes, pansies, geraniums, fuchsias, hibiscus, chrysanthemums, busy lizzies, cyclamen, African violets, sunflowers, begonias), bushes and conifers (for example fig trees, rhododendron, spruce trees, fir trees, pine trees, yew trees, juniper trees, stone pines, rose-bays), herbs and spices (for example aniseed, chilli pepper, bell pepper, pepper, vanilla, marjoram, thyme, cloves, juniper berries, cinnamon, estragon, coriander, saffron, ginger).

According to a further aspect, the invention relates to the preventive or curative use of flubendiamide in combination with beneficial species in the cultivation of annual or perennial crops, preferably greenhouse crops. Preferably, flubendiamide is used in combination with the beneficial species mentioned in Table 2 in the cultivation of the crops mentioned in the same row.

TABLE 2

| No. | Beneficial species | Crop |
|---|---|---|
| 2-1 | A. Aphidius ervi | cotton, pome fruit, stone fruit, nuts, vegetables, maize, rice and soya |
| | | beans |
| 2-2 | Adalia bipunctata | cotton, pome fruit, stone fruit, nuts, vegetables, maize, rice and soya |
| | | beans |
| 2-3 | Aleochara spp. | cotton, pome fruit, stone fruit, nuts, vegetables, maize, rice and soya |
| | | beans |
| 2-4 | Aligota spp. | cotton, pome fruit, stone fruit, nuts, vegetables, maize, rice and soya |
| | | beans |
| 2-5 | Alloxysta spp. | cotton, pome fruit, stone fruit, nuts, vegetables, maize, rice and soya |
| | | beans |
| 2-6 | Amblyseius barkeri | cotton, pome fruit, stone fruit, nuts, vegetables, maize, rice and soya |
| | | beans |
| 2-7 | Amblyseius | cotton, pome fruit, stone fruit, nuts, vegetables, maize, rice and soya |
| | cucumeris | beans |
| 2-8 | Amblyseius spp. | cotton, pome fruit, stone fruit, nuts, vegetables, maize, rice and soya |
| | | beans |
| 2-9 | Ammophila sabulos | cotton, pome fruit, stone fruit, nuts, vegetables, maize, rice and soya |
| | | beans |
| 2-10 | Anatis spp. | cotton, pome fruit, stone fruit, nuts, vegetables, maize, rice and soya |
| | | beans |
| 2-11 | Anthocoris | cotton, pome fruit, stone fruit, nuts, vegetables, maize, rice and soya |
| | nemoralis | beans |
| 2-12 | Anthocoris | cotton, pome fruit, stone fruit, nuts, vegetables, maize, rice and soya |
| | nemorum | beans |
| 2-13 | Apanteles spp. | cotton, pome fruit, stone fruit, nuts, vegetables, maize, rice and soya |
| | | beans |
| 2-14 | codling moth | cotton, pome fruit, stone fruit, nuts, vegetables, maize, rice and soya |
| | granulosis virus | beans |
| 2-15 | Aphelinus | cotton, pome fruit, stone fruit, nuts, vegetables, maize, rice and soya |
| | abdominalis | beans |
| 2-16 | Aphelinus mali | cotton, pome fruit, stone fruit, nuts, vegetables, maize, rice and soya |
| | | beans |
| 2-17 | Aphidencyrtrus spp. | cotton, pome fruit, stone fruit, nuts, vegetables, maize, rice and soya |
| | | beans |
| 2-18 | Aphidius colemani | cotton, pome fruit, stone fruit, nuts, vegetables, maize, rice and soya |
| | | beans |
| 2-19 | Aphidius ervi | cotton, pome fruit, stone fruit, nuts, vegetables, maize, rice and soya |
| | | beans |
| 2-20 | Aphidoletes | cotton, pome fruit, stone fruit, nuts, vegetables, maize, rice and soya |
| | aphidimyza | beans |
| 2-21 | Aphidrus spp. | cotton, pome fruit, stone fruit, nuts, vegetables, maize, rice and soya |
| | | beans |
| 2-22 | Aphytis spp. | cotton, pome fruit, stone fruit, nuts, vegetables, maize, rice and soya |
| | | beans |
| 2-23 | Arma spp. | cotton, pome fruit, stone fruit, nuts, vegetables, maize, rice and soya |
| | | beans |
| 2-24 | Ascogaster spp. | cotton, pome fruit, stone fruit, nuts, vegetables, maize, rice and soya |
| | | beans |
| 2-25 | Atractotomus mali | cotton, pome fruit, stone fruit, nuts, vegetables, maize, rice and soya |
| | | beans |
| 2-26 | Bacillus | cotton, pome fruit, stone fruit, nuts, vegetables, maize, rice and soya |
| | thuringiensis | beans |
| 2-27 | Baculovirus | cotton, pome fruit, stone fruit, nuts, vegetables, maize, rice and soya |
| | | beans |
| 2-28 | Beauveria bassiana | cotton, pome fruit, stone fruit, nuts, vegetables, maize, rice and soya |
| | | beans |
| 2-29 | Beauveria | cotton, pome fruit, stone fruit, nuts, vegetables, maize, rice and soya |
| | brongniartii | beans |
| 2-30 | Bessa fugax | cotton, pome fruit, stone fruit, nuts, vegetables, maize, rice and soya |
| | | beans |
| 2-31 | Blepharidopterus | cotton, pome fruit, stone fruit, nuts, vegetables, maize, rice and soya |
| | angulatus | beans |
| 2-32 | Camylomma | cotton, pome fruit, stone fruit, nuts, vegetables, maize, rice and soya |
| | verbasci | beans |
| 2-33 | Cerceris arenaria | cotton, pome fruit, stone fruit, nuts, vegetables, maize, rice and soya |
| | | beans |
| 2-34 | Chilocorus | cotton, pome fruit, stone fruit, nuts, vegetables, maize, rice and soya |
| | bipustulatus | beans |
| 2-35 | Chrysopa carnea | cotton, pome fruit, stone fruit, nuts, vegetables, maize, rice and soya |
| | | beans |
| 2-36 | Chrysopa flava | cotton, pome fruit, stone fruit, nuts, vegetables, maize, rice and soya |
| | | beans |
| 2-37 | Chrysopa oculata | cotton, pome fruit, stone fruit, nuts, vegetables, maize, rice and soya |
| | | beans |
| 2-38 | Chrysopa perla | cotton, pome fruit, stone fruit, nuts, vegetables, maize, rice and soya |
| | | beans |
| 2-39 | Chrysopa | cotton, pome fruit, stone fruit, nuts, vegetables, maize, rice and soya |
| | septempunctata | beans |
| 2-40 | Chrysoperla carnea | cotton, pome fruit, stone fruit, nuts, vegetables, maize, rice and soya |
| | | beans |
| 2-41 | Chrysoperla spp. | cotton, pome fruit, stone fruit, nuts, vegetables, maize, rice and soya |
| | | beans |
| 2-42 | Chrysopidia ciliata | cotton, pome fruit, stone fruit, nuts, vegetables, maize, rice and soya |
| | | beans |
| 2-43 | Coccigomymus spp. | cotton, pome fruit, stone fruit, nuts, vegetables, maize, rice and soya |
| | | beans |
| 2-44 | Coccinella | cotton, pome fruit, stone fruit, nuts, vegetables, maize, rice and soya |
| | septempunctata | beans |
| 2-45 | Coccinellidae | cotton, pome fruit, stone fruit, nuts, vegetables, maize, rice and soya |
| | | beans |
| 2-46 | Coccophagus spp. | cotton, pome fruit, stone fruit, nuts, vegetables, maize, rice and soya |
| | | beans |
| 2-47 | Colpoclypeus florus | cotton, pome fruit, stone fruit, nuts, vegetables, maize, rice and soya |
| | | beans |
| 2-48 | Compsileura | cotton, pome fruit, stone fruit, nuts, vegetables, maize, rice and soya |
| | concinnata | beans |
| 2-49 | Cryptolaemus | cotton, pome fruit, stone fruit, nuts, vegetables, maize, rice and soya |
| | montrouzieri | beans |
| 2-50 | Cyzenius albicans | cotton, pome fruit, stone fruit, nuts, vegetables, maize, rice and soya |
| | | beans |
| 2-51 | Dabnusa sibirica | cotton, pome fruit, stone fruit, nuts, vegetables, maize, rice and soya |
| | | beans |
| 2-52 | Dacnusa spp. | cotton, pome fruit, stone fruit, nuts, vegetables, maize, rice and soya |
| | | beans |
| 2-53 | Dasysyrphus spp. | cotton, pome fruit, stone fruit, nuts, vegetables, maize, rice and soya |
| | | beans |
| 2-54 | Dendrocerus spp. | cotton, pome fruit, stone fruit, nuts, vegetables, maize, rice and soya |
| | | beans |
| 2-55 | Deraeocoris spp. | cotton, pome fruit, stone fruit, nuts, vegetables, maize, rice and soya |
| | | beans |
| 2-56 | Diadegma spp. | cotton, pome fruit, stone fruit, nuts, vegetables, maize, rice and soya |
| | | beans |
| 2-57 | Diaeretiella spp. | cotton, pome fruit, stone fruit, nuts, vegetables, maize, rice and soya |
| | | beans |
| 2-58 | Diglyphus isaea | cotton, pome fruit, stone fruit, nuts, vegetables, maize, rice and soya |
| | | beans |
| 2-59 | Dolichovespula | cotton, pome fruit, stone fruit, nuts, vegetables, maize, rice and soya |
| | spp. | beans |
| 2-60 | Elodia tragica | cotton, pome fruit, stone fruit, nuts, vegetables, maize, rice and soya |
| | | beans |
| 2-61 | Empicornis | cotton, pome fruit, stone fruit, nuts, vegetables, maize, rice and soya |
| | vagabundus | beans |
| 2-62 | Encarsia formosa | cotton, pome fruit, stone fruit, nuts, vegetables, maize, rice and soya |
| | | beans |
| 2-63 | Encyrtus fuscicollis | cotton, pome fruit, stone fruit, nuts, vegetables, maize, rice and soya |
| | | beans |
| 2-64 | Episyrphus | cotton, pome fruit, stone fruit, nuts, vegetables, maize, rice and soya |
| | balteatus | beans |
| 2-65 | Erelmocerus | cotton, pome fruit, stone fruit, nuts, vegetables, maize, rice and soya |
| | erimicus | beans |
| 2-66 | Eulophus viridula | cotton, pome fruit, stone fruit, nuts, vegetables, maize, rice and soya |
| | | beans |
| 2-67 | Eumenes spp., | cotton, pome fruit, stone fruit, nuts, vegetables, maize, rice and soya |
| | | beans |
| 2-68 | Exochomus spp. | cotton, pome fruit, stone fruit, nuts, vegetables, maize, rice and soya |
| | | beans |
| 2-69 | Exorista larvarum | cotton, pome fruit, stone fruit, nuts, vegetables, maize, rice and soya |
| | | beans |
| 2-70 | Feltiella acarisuga | cotton, pome fruit, stone fruit, nuts, vegetables, maize, rice and soya |
| | | beans |
| 2-71 | Glypta spp. | cotton, pome fruit, stone fruit, nuts, vegetables, maize, rice and soya |
| | | beans |
| 2-72 | Harmonia spp. | cotton, pome fruit, stone fruit, nuts, vegetables, maize, rice and soya |
| | | beans |
| 2-73 | Hemerobius | cotton, pome fruit, stone fruit, nuts, vegetables, maize, rice and soya |
| | fenestratus | beans |
| 2-74 | Hemerobius | cotton, pome fruit, stone fruit, nuts, vegetables, maize, rice and soya |
| | humulinus | beans |
| 2-75 | Hemerobius micans | cotton, pome fruit, stone fruit, nuts, vegetables, maize, rice and soya |
| | | beans |
| 2-76 | Hemerobius | cotton, pome fruit, stone fruit, nuts, vegetables, maize, rice and soya |
| | nitidulus | beans |
| 2-77 | Hemerobius pini | cotton, pome fruit, stone fruit, nuts, vegetables, maize, rice and soya |
| | | beans |
| 2-78 | Heterorhabditis | cotton, pome fruit, stone fruit, nuts, vegetables, maize, rice and soya |
| | spp. | beans |
| 2-79 | Hypoaspis aculeifer | cotton, pome fruit, stone fruit, nuts, vegetables, maize, rice and soya |
| | | beans |
| 2-80 | Hypoaspis miles | cotton, pome fruit, stone fruit, nuts, vegetables, maize, rice and soya |
| | | beans |
| 2-81 | Hypochrysa | cotton, pome fruit, stone fruit, nuts, vegetables, maize, rice and soya |
| | elegans | beans |
| 2-82 | fungi pathogenic to | cotton, pome fruit, stone fruit, nuts, vegetables, maize, rice and soya |
| | insects | beans |
| 2-83 | Leptomastix | cotton, pome fruit, stone fruit, nuts, vegetables, maize, rice and soya |
| | abnormis | beans |
| 2-84 | Leptomastix | cotton, pome fruit, stone fruit, nuts, vegetables, maize, rice and soya |
| | dactylop | beans |
| 2-85 | Lyphia dubia | cotton, pome fruit, stone fruit, nuts, vegetables, maize, rice and soya |
| | | beans |
| 2-86 | Lysiphlebus spp. | cotton, pome fruit, stone fruit, nuts, vegetables, maize, rice and soya |
| | | beans |
| 2-87 | Lysiphlebus | cotton, pome fruit, stone fruit, nuts, vegetables, maize, rice and soya |
| | testaceipes | beans |
| 2-88 | Macrocentrus spp. | cotton, pome fruit, stone fruit, nuts, vegetables, maize, rice and soya |
| | | beans |
| 2-89 | Macrolophus | cotton, pome fruit, stone fruit, nuts, vegetables, maize, rice and soya |
| | pygmaeus | beans |
| 2-90 | Macrolophus | cotton, pome fruit, stone fruit, nuts, vegetables, maize, rice and soya |
| | caliginosus | beans |
| 2-91 | Melangyna | cotton, pome fruit, stone fruit, nuts, vegetables, maize, rice and soya |
| | triangulata | beans |
| 2-92 | Melanostoma spp. | cotton, pome fruit, stone fruit, nuts, vegetables, maize, rice and soya |
| | | beans |
| 2-93 | Metarhizium | cotton, pome fruit, stone fruit, nuts, vegetables, maize, rice and soya |
| | anisopliae | beans |
| 2-94 | Metarhizium | cotton, pome fruit, stone fruit, nuts, vegetables, maize, rice and soya |
| | acridum | beans |
| 2-95 | Metasyrphus spp. | cotton, pome fruit, stone fruit, nuts, vegetables, maize, rice and soya |
| | | beans |
| 2-96 | Nabis apterus | cotton, pome fruit, stone fruit, nuts, vegetables, maize, rice and soya |
| | | beans |
| 2-97 | Ophion spp. | cotton, pome fruit, stone fruit, nuts, vegetables, maize, rice and soya |
| | | beans |
| 2-98 | Opius spp. | cotton, pome fruit, stone fruit, nuts, vegetables, maize, rice and soya |
| | | beans |
| 2-99 | Oplomerus spp. | cotton, pome fruit, stone fruit, nuts, vegetables, maize, rice and soya |
| | | beans |
| 2-100 | Orius insidiosus | cotton, pome fruit, stone fruit, nuts, vegetables, maize, rice and soya |
| | | beans |
| 2-101 | Orius laevigatus | cotton, pome fruit, stone fruit, nuts, vegetables, maize, rice and soya |
| | | beans |
| 2-102 | Orius majusculus | cotton, pome fruit, stone fruit, nuts, vegetables, maize, rice and soya |
| | | beans |
| 2-103 | Orius minutus | cotton, pome fruit, stone fruit, nuts, vegetables, maize, rice and soya |
| | | beans |
| 2-104 | Orius niger | cotton, pome fruit, stone fruit, nuts, vegetables, maize, rice and soya |
| | | beans |
| 2-105 | Orius vicinus | cotton, pome fruit, stone fruit, nuts, vegetables, maize, rice and soya |
| | | beans |
| 2-106 | Paravespula spp. | cotton, pome fruit, stone fruit, nuts, vegetables, maize, rice and soya |
| | | beans |
| 2-107 | Philonthus spp. | cotton, pome fruit, stone fruit, nuts, vegetables, maize, rice and soya |
| | | beans |
| 2-108 | Phytoseiulus | cotton, pome fruit, stone fruit, nuts, vegetables, maize, rice and soya |
| | persimilis | beans |
| 2-109 | Phytoseiulus spp. | cotton, pome fruit, stone fruit, nuts, vegetables, maize, rice and soya |
| | | beans |
| 2-110 | Pimpla spp. | cotton, pome fruit, stone fruit, nuts, vegetables, maize, rice and soya |
| | | beans |
| 2-111 | Platycheirus spp. | cotton, pome fruit, stone fruit, nuts, vegetables, maize, rice and soya |
| | | beans |
| 2-112 | Podisus | cotton, pome fruit, stone fruit, nuts, vegetables, maize, rice and soya |
| | maculiventris | beans |
| 2-113 | Polistes spp. | cotton, pome fruit, stone fruit, nuts, vegetables, maize, rice and soya |
| | | beans |
| 2-114 | Praon spp. | cotton, pome fruit, stone fruit, nuts, vegetables, maize, rice and soya |
| | | beans |
| 2-115 | Prospaltella spp., | cotton, pome fruit, stone fruit, nuts, vegetables, maize, rice and soya |
| | | beans |
| 2-116 | Reduvius | cotton, pome fruit, stone fruit, nuts, vegetables, maize, rice and soya |
| | personatus | beans |
| 2-117 | Rhinocoris spp. | cotton, pome fruit, stone fruit, nuts, vegetables, maize, rice and soya |
| | | beans |
| 2-118 | Rhizobius spp. | cotton, pome fruit, stone fruit, nuts, vegetables, maize, rice and soya |
| | | beans |
| 2-119 | Scymnus abietes | cotton, pome fruit, stone fruit, nuts, vegetables, maize, rice and soya |
| | | beans |
| 2-120 | Scymnus | cotton, pome fruit, stone fruit, nuts, vegetables, maize, rice and soya |
| | interruptus | beans |
| 2-121 | Scymnus spp. | cotton, pome fruit, stone fruit, nuts, vegetables, maize, rice and soya |
| | | beans |
| 2-122 | Staphylinus spp. | cotton, pome fruit, stone fruit, nuts, vegetables, maize, rice and soya |
| | | beans |
| 2-123 | Steinernema | cotton, pome fruit, stone fruit, nuts, vegetables, maize, rice and soya |
| | carpocapsae | beans |
| 2-124 | Steinernema feltiae | cotton, pome fruit, stone fruit, nuts, vegetables, maize, rice and soya |
| | | beans |
| 2-125 | Stethorus spp. | cotton, pome fruit, stone fruit, nuts, vegetables, maize, rice and soya |
| | | beans |
| 2-126 | Syrphus spp. | cotton, pome fruit, stone fruit, nuts, vegetables, maize, rice and soya |
| | | beans |
| 2-127 | Thanasimus | cotton, pome fruit, stone fruit, nuts, vegetables, maize, rice and soya |
| | formicarius | beans |
| 2-128 | Thea spp. | cotton, pome fruit, stone fruit, nuts, vegetables, maize, rice and soya |
| | | beans |
| 2-129 | Thyphlodromus | cotton, pome fruit, stone fruit, nuts, vegetables, maize, rice and soya |
| | spp. | beans |
| 2-130 | Trichogamma | cotton, pome fruit, stone fruit, nuts, vegetables, maize, rice and soya |
| | brassicae | beans |
| 2-131 | Trichogramma | cotton, pome fruit, stone fruit, nuts, vegetables, maize, rice and soya |
| | cacoeciae | beans |
| 2-132 | Trichogramma | cotton, pome fruit, stone fruit, nuts, vegetables, maize, rice and soya |
| | dendrolimi | beans |
| 2-133 | Trichogramma | cotton, pome fruit, stone fruit, nuts, vegetables, maize, rice and soya |
| | evanescens | beans |
| 2-134 | Trichogramma spp. | cotton, pome fruit, stone fruit, nuts, vegetables, maize, rice and soya |
| | | beans |
| 2-135 | Vespa spp. | cotton, pome fruit, stone fruit, nuts, vegetables, maize, rice and soya |
| | | beans |
| 2-136 | Vespula spp. | cotton, pome fruit, stone fruit, nuts, vegetables, maize, rice and soya |
| | | beans |
| 2-137 | Wesmaelius | cotton, pome fruit, stone fruit, nuts, vegetables, maize, rice and soya |
| | nervosus | beans |
| 2-138 | fairyflies | cotton, pome fruit, stone fruit, nuts, vegetables, maize, rice and soya |
| | (Mymaridae) | beans |

When using the combinations according to the invention of flubendiamide and beneficial species for controlling animal pests, i.e. as insecticides and/or acaricides, the application rate of flubendiamide can be varied within a relatively wide range depending on the type of application. In the treatment of parts of plants, for example leaves, it is from 0.1 to 1000 g/ha, preferably from 1 to 500 g/ha, particularly preferably from 10 to 300 g/ha. When the application is by watering or dripping, in particular in combination with soil-less substrates, the application rate is from 0.01 to 50 mg/plant, preferably from 0.1 to 10 mg/plant, particularly preferably from 0.5 to 5 mg/plant.

In preventative applications, the combination according to the invention of flubendiamide and beneficial species is used to protect plants for a certain period of time after the treatment against attack by animal pests.

In curative applications, the combination according to the invention of flubendiamide and beneficial species is used to rid plants of an infestation by animal pests.

Both in curative and preventative applications of the combination according to the invention, it is advantageous to treat plants of annual or perennial crops growing on soil-less substates. Here, flubendiamide is advantageously applied by treating the cultivation substrate. In this manner, the combinations according to the invention of flubendiamide and beneficial species are easy and effective to use, and flubendiamide can be used in a lower dosage.

Application of the cultivation substrate is understood as meaning bringing flubendiamide into contact with the soil-less substrate. This may be in particular by spraying, watering, side dressing, shower drenching, overhead drenching or by drip irrigation, i.e. application in connection with an irrigation system. Addition of the active compound to the aqueous phase surrounding the roots of the plants may be, for example, by the floating, box or paddy field method.

Soil-less substrates are understood as meaning in particular substrates which are not naturally grown or synthetically produced from inorganic minerals and organic humus. Soil-less substrates are, for example, specific substrates based on peat mosses, coconut fibres, rock wool (for example Grodan®), pumice, expanded clay (for example Lecaton® or Lecadan®) clay granules (for example Seramis®), expanded plastic (for example Baystrat®), vermiculite, perlite, artificial soil (for example Hygromull®), or combinations thereof. Preferred substrates are perlite and rock wool.

The combinations according to the invention of flubendiamide and beneficial species, having good compatibility with plants and in particular good enviromental compatibility, are suitable for protecting plants and plant organs. This may result in increased harvest yields and an improved quality of the harvested material.

The combination is preferably employed in crop protection. Here in particular in agriculture, horticulture, in forests, in gardens and in leasure facilities. The combinations can also be used in the protection of stored products and in the protection of materials. The combination is active against normally sensitive and resistant species and against all or some stages of development.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Cerotoma trifurcata, Ceuthorhynchus spp., Cleonus mendicus, Conoderus spp., Cosmopolites spp., Costelytra zealandica, Ctenicera spp., Curculio spp., Cryptorhynchus lapathi, Dermestes spp., Diabrotica spp., Dichocrocis spp., Diloboderus spp., Epilachna spp., Epitrix spp., Faustinus cubae, Gibbium psylloides, Hellula undalis, Heteronychus arator, Heteronyx spp., Hylamorpha elegans, Hylotrupes bajulus, Hypera postica, Hypothenemus spp., Lachnosterna consanguinea, Lema spp., Leptinotarsa decemlineata, Leucoptera spp., Lissorhoptrus oryzophilus, Lixus spp., Lyctus spp., Meligethes aeneus, Melolontha spp., Migdolus spp., Monochamus spp., Naupactus xanthographus, Niptus hololeucus, Oryctes rhinoceros, Oryzaephilus surinamensis, Otiorrhynchus spp., Oxycetonia jucunda, Perileucoptera spp., Phaedon cochleariae, Phyllophaga spp., Phyllotreta spp., Popillia japonica, Premnotrypes spp., Psylliodes spp., Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus sp.

From the order of the Dermaptera, for example, Forficula auricularia.

From the order of the Diplopoda, for example, Blaniulus guttulatus.

From the order of the Diptera, for example, Aedes spp., Agromyza spp., Anopheles spp., Bactrocera spp., Bibio hortulanus, Calliphora erythrocephala, Ceratitis capitata, Chrysomyia spp., Cochliomyia spp., Contarinia spp., Cordylobia anthropophaga, Culex spp., Cuterebra spp., Dacus oleae, Delia spp., Dermatobia hominis, Drosophila spp., Fannia spp., Gastrophilus spp., Hylemyia spp., Hyppobosca spp., Hypoderma spp., Liriomyza spp. Lucilia spp., Musca spp., Nezara spp., Oestrus spp., Oscinella frit, Pegomyia hyoscyami, Phorbia spp., Prodiplosis spp., Rhagoletis spp., Stomoxys spp., Tabanus spp., Tannia spp., Tipula spp.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Drosicha spp., Dysaphis spp., Dysmicoccus spp., Empoasca spp., Eriosoma spp., Erythroneura spp., Euscelis bilobatus, Geococcus coffeae, Hieroglyphus spp., Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes spp., Trioza spp., Typhlocyba spp., Unaspis spp., Viteus vitifolii, Zygina spp.

From the order of the Isoptera, for example, Acromyrmex spp., Reticulitermes spp, Cornitermes cumulans, Microtermes obesi.

From the order of the Lepidoptera, for example, Acronicta major, Adoxophyes spp., Aedia leucomelas, Agrotis spp., Alabama argillacea, Amyelois transitella, Anarsia lineatella, Anticarsia spp., Barathra brassicae, Borbo cinnara, Bucculatrix thurberiella, Bupalus piniarius, Cacoecia spp., Caloptilia theivora, Capua reticulana, Carpocapsa pomonella, Carposina niponensis, Chematobia brumata, Chilo spp., Choristoneura fumiferana, Clysia ambiguella, Cnaphalocerus spp., Dalaca noctuides, Diaphania indica, Diatraea saccharalis, Earias spp., Ecdytolopha aurantium, Elasmopalpus lignosellus, Eldana saccharina, Ephestia kuehniella, Eulia spp., Eupoecilia ambiguella, Euproctis chrysorrhoea, Euxoa spp., Feltia spp., Galleria mellonella, Gracillaria spp., Grapholitha spp., Helicoverpa spp., Heliothis spp., Hofmannophila pseudospretella, Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamestra brassicae, Mocis repanda, Mythimna separata, Nymphula spp., Oiketicus spp., Oria spp., Ostrinia spp., Oulema oryzae, Panolis flammea, Pectinophora spp., Phthorimaea spp., Phyllocnistis citrella, Pieris spp., Platynota stultana, Plusia spp., Plutella xylostella, Prays spp., Prodenia spp., Pseudaletia spp., Pseudoplusia includens, Pyrausta nubilalis, Rachiplusia nu, Scirpophaga spp., Sesamia spp., Sparganothis spp., Spodoptera spp., Stomopteryx subsecivella, Tecia solanivora, Thermesia gemmatalis, Tinea pellionella, Tineola bisselliella, Tortrix spp., Trichoplusia spp., Tuta absoluta.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

Flubendiamide can be converted inti the customary formulations, such as solutions, emulsions, wettable powders, water- and oil-based suspensions, powders, dusts, pastes, soluble powders, soluble granules, granules for broadcasting, suspoemulsion concentrates, natural compounds impregnated with flubendiamide, synthetic substances impregnated with flubendiamide, fertilizers and also microencapsulations in polymeric substances.

These formulations are produced in a known manner, for example by mixing the active compounds with extenders, that is, liquid solvents, and/or solid carriers, optionally with the use of surfactants, that is to say emulsifiers and/or dispersants, and/or foam-formers. The formulations are prepared either in suitable plants or else before or during application.

Suitable for use as auxiliaries are substances which are suitable for imparting to the composition itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatic hydrocarbons and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethyl sulphoxide, and also water.

According to the invention, a carrier is a natural or synthetic, organic or inorganic substance which may be solid or liquid and with which the active compounds are mixed or bonded for better applicability, in particular for application to plants or plant parts or seed. The solid or liquid carrier is generally inert and should be suitable for use in agriculture.

Suitable solid or liquid carriers are:

for example ammonium salts and ground natural minerals such as kaolins, clays, talc, chalk, quartz, attapulgite, montmorillonite or diatomaceous earth, and ground synthetic materials such as highly-disperse silica, alumina and silicates; suitable solid carriers for granules are: for example, crushed and fractionated natural rocks such as calcite, marble, pumice, sepiolite and dolomite, and also synthetic granules of inorganic and organic meals, and granules of organic material such as paper, sawdust, coconut shells, maize cobs and tobacco stalks; suitable emulsifiers and/or foam-formers are: for example, nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or -POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Furthermore, suitable oligo- or polymers, for example those derived from vinylic monomers, from acrylic acid, from EO and/or PO alone or in combination with, for example, (poly)alcohols or (poly)amines. It is also possible to employ lignin and its sulphonic acid derivatives, unmodified and modified celluloses, aromatic and/or aliphatic sulphonic acids and their adducts with formaldehyde.

Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations.

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

Other possible additives are perfumes, mineral or vegetable, optionally modified oils, waxes and nutrients (including trace nutrients), such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present.

The active compound content of the use forms prepared from the commercially available formulations can vary within wide limits. The total active compound concentration, or the active compound concentration of the individual active compounds of the use forms is in the range of from 0.000001 to 97% by weight of active compound, preferably in the range of from 0.0001 to 80% by weight, particularly preferably in the range of from 0.001 to 65% by weight and very particularly preferably in the range of from 0.01 to 50% by weight.

The combinations according to the invention of flubendiamide and beneficial species can be present in their commercially available formulations and in the use forms, prepared from these formulations, as a mixture with other active compounds, such as insecticides, attractants, sterilizing agents, bactericides, acaricides, nematicides, fungicides, growth-regulating substances, herbicides, safeners, fertilizers or semiochemicals.

A mixture with other known active compounds, such as herbicides, fertilizers, growth regulators, safeners, semiochemicals, or else with agents for improving the plant properties, is also possible.

In the combination according to the invention of flubendiamide and beneficial species, flubendiamide can be present in its commercially available formulations and in the use forms, prepared from these formulations, as a mixture with synergistis. Synergists are compounds which increase the action of the active compounds, without it being necessary for the synergist added to be active itself.

When used as insecticides, the combinations according to the invention of flubendiamide and beneficial species can furthermore be present in their commercially available formulations and in the use forms, prepared from these formulations, as a mixture with inhibitors which reduce degradation of the active compound after use in the environment of the plant, on the surface of parts of plants or in plant tissues.

The compounds are employed in a customary manner appropriate for the use forms.

All plants and plant parts can be treated in accordance with the invention. By plants are understood here all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant varieties which can or cannot be protected by varietal property rights. Preference is given to treating annual or perennial crop plants. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. The plant parts also include harvested material and also vegetative and generative propagation material, for example fruits, seeds, cuttings, tubers, rhizomes, slips, seed, bulbils, layers and runners.

In addition to the treatment of soil-less substrates mentioned above, the treatment according to the invention of the plants and parts of plants with the combinations of flubendiamide and beneficial species is carried out directly or by allowing the combinations to act on their surroundings, habitat or storage space by the customary treatment methods, for example by immersion, spraying, evaporation, fogging, scattering, painting on, inoculation or application of the beneficial species or injection.

In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, such as, for example, antisense or cosuppression technology, RNA interference—RNAi—technology, if appropriate in combination with conventional methods (Genetically Modified Organisms), and parts thereof are treated. The term “parts” or “parts of plants” or “plant parts” has been explained above.

Particularly preferably, plants of the plant cultivars which are in each case commercially available or in use are treated according to the invention. Plant cultivars are to be understood as meaning plants having new properties (“traits”) and which have been obtained by conventional breeding, by mutagenesis or with the aid of recombinant DNA techniques. Crop plants can thus be plants which can be obtained by conventional breeding and optimization methods or by biotechnological and genetic engineering methods or combinations of these methods, including the transgenic plants and including the plant varieties which can or cannot be protected by varietal property rights.

The method of treatment according to the invention can therefore also be used in the treatment of genetically modified organisms (GMOs), e.g. plants or seeds. Genetically modified plants (or transgenic plants) are plants in which a heterologous gene has been stably integrated into the genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example antisense technology, cosuppression technology or RNAi technology [RNA interference]). A heterologous gene that is located in the genome is also called a transgene. A transgene that is defined by its particular location in the plant genome is called a transformation or transgenic event.

Plants and plant varieties which are preferably to be treated according to the invention include all plants which have genetic material which imparts particularly advantageous, useful traits to these plants (whether obtained by breeding and/or biotechnological means).

Plants and plant varieties which may also be treated according to the invention are those plants which are resistant to one or more abiotic stress factors. Abiotic stress conditions may include, for example, drought, cold temperature exposure, heat exposure, osmotic stress, waterlogging, increased soil salinity, increased exposure to minerals, exposure to ozone, exposure to strong light, limited availability of nitrogen nutrients, limited availability of phosphorus nutrients or shade avoidance.

Plants and plant varieties which may also be treated according to the invention are those plants characterized by enhanced yield characteristics Enhanced yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including early flowering, flowering control for hybrid seed production, seedling vigour, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may be treated according to the invention are hybrid plants that already express the characteristics of heterosis, or hybrid vigour, which results in generally higher yield, vigour, health and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in corn) be produced by detasseling (i.e. the mechanical removal of the male reproductive organs or male flowers) but, more typically, male sterility is the result of genetic determinants in the plant genome. In that case, and especially when seed is the desired product to be harvested from the hybrid plants, it is typically useful to ensure that male fertility in the hybrid plants, which contain the genetic determinants responsible for male sterility, is fully restored. This can be accomplished by ensuring that the male parents have appropriate fertility restorer genes which are capable of restoring the male fertility in hybrid plants that contain the genetic determinants responsible for male sterility. Genetic determinants for male sterility may be located in the cytoplasm. Examples of cytoplasmic male sterility (CMS) were for instance described in Brassica species (WO 1992/005251, WO 1995/009910, WO 1998/27806, WO 2005/002324, WO 2006/021972 and U.S. Pat. No. 6,229,072). However, genetic determinants for male sterility can also be located in the nuclear genome. Male sterile plants can also be obtained by plant biotechnology methods such as genetic engineering. A particularly useful means of obtaining male sterile plants is described in WO 89/10396 in which, for example, a ribonuclease such as barnase is selectively expressed in the tapetum cells in the stamens. Fertility can then be restored by expression in the tapetum cells of a ribonuclease inhibitor such as barstar (e.g. WO 1991/002069).

Plants or plant varieties (obtained by plant biotechnology methods such as genetic engineering) which may be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., Science (1983), 221, 370-371), the CP4 gene of the bacterium Agrobacterium sp. (Barry et al., Curr. Topics Plant Physiol. (1992), 7, 139-145), the genes encoding a petunia EPSPS (Shah et al., Science (1986), 233, 478-481), a tomato EPSPS (Gasser et al., J. Biol. Chem. (1988), 263, 4280-4289) or an Eleusine EPSPS (WO 2001/66704). It can also be a mutated EPSPS, as described, for example, in EP-A 0837944, WO 2000/066746, WO 2000/066747 or WO 2002/026995. Glyphosate-tolerant plants can also be obtained by expressing a gene that encodes a glyphosate oxidoreductase enzyme as described in U.S. Pat. No. 5,776,760 and U.S. Pat. No. 5,463,175. Glyphosate-tolerant plants can also be obtained by expressing a gene that encodes a glyphosate acetyl transferase enzyme as described, for example, in WO 2002/036782, WO 2003/092360, WO 2005/012515 and WO 2007/024782. Glyphosate-tolerant plants can also be obtained by selecting plants containing naturally occurring mutations of the above-mentioned genes as described, for example, in WO 2001/024615 or WO 2003/013226.

Other herbicide-resistant plants are for example plants which have been made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One such efficient detoxifying enzyme is, for example, an enzyme encoding a phosphinothricin acetyltransferase (such as the bar or pat protein from Streptomyces species). Plants expressing an exogenous phosphinothricin acetyltransferase have been described, for example, in U.S. Pat. No. 5,561,236; U.S. Pat. No. 5,648,477; U.S. Pat. No. 5,646,024; U.S. Pat. No. 5,273,894; U.S. Pat. No. 5,637,489; U.S. Pat. No. 5,276,268; U.S. Pat. No. 5,739,082; U.S. Pat. No. 5,908,810 and U.S. Pat. No. 7,112,665.

Further herbicide-tolerant plants are also plants that are made tolerant to the herbicides inhibiting the enzyme hydroxyphenylpyruvatedioxygenase (HPPD). Hydroxyphenylpyruvatedioxygenases are enzymes that catalyse the reaction in which para-hydroxyphenylpyruvate (HPP) is transformed into homogentisate. Plants tolerant to HPPD-inhibitors can be transformed with a gene encoding a naturally-occurring resistant HPPD enzyme, or a gene encoding a mutated HPPD enzyme according to WO 1996/038567, WO 1999/024585 and WO 1999/024586. Tolerance to HPPD-inhibitors can also be obtained by transforming plants with genes encoding certain enzymes enabling the formation of homogentisate despite the inhibition of the native HPPD enzyme by the HPPD-inhibitor. Such plants and genes are described in WO 1999/034008 and WO 2002/36787. Tolerance of plants to HPPD inhibitors can also be improved by transforming plants with a gene encoding an enzyme prephenate dehydrogenase in addition to a gene encoding an HPPD-tolerant enzyme, as described in WO 2004/024928.

Further herbicide-resistant plants are plants that have been made tolerant to acetolactate synthase (ALS) inhibitors. Known ALS inhibitors include, for example, sulphonylurea, imidazolinone, triazolopyrimidines, pyrimidinyloxy(thio)benzoates, and/or sulphonylaminocarbonyltriazolinone herbicides. Different mutations in the ALS enzyme (also known as acetohydroxy acid synthase, AHAS) are known to confer tolerance to different herbicides and groups of herbicides, as described, for example, in Tranel and Wright, Weed Science (2002), 50, 700-712, and also in U.S. Pat. No. 5,605,011, U.S. Pat. No. 5,378,824, U.S. Pat. No. 5,141,870 and U.S. Pat. No. 5,013,659. The production of sulphonylurea-tolerant plants and imidazolinone-tolerant plants has been described in U.S. Pat. No. 5,605,011; U.S. Pat. No. 5,013,659; U.S. Pat. No. 5,141,870; U.S. Pat. No. 5,767,361; U.S. Pat. No. 5,731,180; U.S. Pat. No. 5,304,732; U.S. Pat. No. 4,761,373; U.S. Pat. No. 5,331,107; U.S. Pat. No. 5,928,937; and U.S. Pat. No. 5,378,824; and also in the international publication WO 1996/033270. Further imidazolinone-tolerant plants have also been described, for example in WO 2004/040012, WO 2004/106529, WO 2005/020673, WO 2005/093093, WO 2006/007373, WO 2006/015376, WO 2006/024351 and WO 2006/060634. Further sulphonylurea- and imidazolinone-tolerant plants have also been described, for example in WO 2007/024782.

Other plants tolerant to imidazolinone and/or sulphonylurea can be obtained by induced mutagenesis, by selection in cell cultures in the presence of the herbicide or by mutation breeding, as described, for example, for soya beans in U.S. Pat. No. 5,084,082, for rice in WO 1997/41218, for sugar beet in U.S. Pat. No. 5,773,702 and WO 1999/057965, for lettuce in U.S. Pat. No. 5,198,599 or for sunflower in WO 2001/065922.

Plants or plant varieties (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

In the present context, the term “insect-resistant transgenic plant” includes any plant containing at least one transgene comprising a coding sequence encoding:
1) an insecticidal crystal protein from Bacillus thuringiensis or an insecticidal portion thereof, such as the insecticidal crystal proteins listed by Crickmore et al., Microbiology and Molecular Biology Reviews (1998), 62, 807-813, updated by Crickmore et al. (2005) in the Bacillus thuringiensis toxin nomenclature, online at:
   http://www.lifesci.sussex.ac.uk/Home/Neil_Crickmore/Bt/), or insecticidal portions thereof, for example proteins of the Cry protein classes Cry1Ab, Cry1Ac, Cry1F, Cry2Ab, Cry3Ae or Cry3Bb or insecticidal portions thereof; or
2) a crystal protein from Bacillus thuringiensis or a portion thereof which is insecticidal in the presence of a second other crystal protein from Bacillus thuringiensis or a portion thereof, such as the binary toxin made up of the Cy34 and Cy35 crystal proteins (Moellenbeck et al., Nat. Biotechnol. (2001), 19, 668-72; Schnepf et al., Applied Environm Microb. (2006), 71, 1765-1774); or
3) a hybrid insecticidal protein comprising parts of two different insecticidal crystal proteins from Bacillus thuringiensis, such as a hybrid of the proteins of 1) above or a hybrid of the proteins of 2) above, for example the Cry1A.105 protein produced by maize event MON98034 (WO 2007/027777); or
4) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation, such as the Cry3Bb1 protein in maize events MON863 or MON88017, or the Cry3A protein in maize event MIR604; or
5) an insecticidal secreted protein from Bacillus thuringiensis or Bacillus cereus, or an insecticidal portion thereof, such as the vegetative insecticidal proteins (VIP) listed at: http://www.lifesci.sussex.ac.uk/home/Neil_Crickmore/Bt/vip.html, for example proteins from the VIP3Aa protein class; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 1994/21795); or
7) a hybrid insecticidal protein comprising parts from different secreted proteins from Bacillus thuringiensis or Bacillus cereus, such as a hybrid of the proteins in 1) above or a hybrid of the proteins in 2) above; or
8) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation (while still encoding an insecticidal protein), such as the VIP3Aa protein in cotton event COT 102.

Of course, insect-resistant transgenic plants, as used herein, also include any plant comprising a combination of genes encoding the proteins of any one of the above classes 1 to 8. In one embodiment, an insect-resistant plant contains more than one transgene encoding a protein of any one of the above classes 1 to 8, to expand the range of target insect species affected or to delay insect resistance development to the plants, by using different proteins insecticidal to the same target insect species but having a different mode of action, such as binding to different receptor binding sites in the insect.

Plants or plant varieties (obtained by plant biotechnology methods such as genetic engineering) which may also be treated according to the invention are tolerant to abiotic stress factors. Such plants can be obtained by genetic transformation, or by selection of plants containing a mutation imparting such stress resistance. Particularly useful stress-tolerant plants include the following:
a. plants which contain a transgene capable of reducing the expression and/or the activity of the poly(ADP-ribose)polymerase (PARP) gene in the plant cells or plants, as described in WO 2000/004173 or EP 04077984.5 or EP 06009836.5.
b. plants which contain a stress tolerance-enhancing transgene capable of reducing the expression and/or the activity of the PARG encoding genes of the plants or plant cells, as described, for example, in WO 2004/090140;
c. plants which contain a stress tolerance-enhancing transgene coding for a plant-functional enzyme of the nicotinamide adenine dinucleotide salvage biosynthesis pathway, including nicotinamidase, nicotinate phosphoribosyltransferase, nicotinic acid mononucleotide adenyl transferase, nicotinamide adenine dinucleotide synthetase or nicotinamide phosphoribosyltransferase, as described, for example, in EP 04077624.7 or WO 2006/133827 or PCT/EP07/002,433.

Plants or plant varieties (obtained by plant biotechnology methods such as genetic engineering) which may also be treated according to the invention show altered quantity, quality and/or storage-stability of the harvested product and/or altered properties of specific ingredients of the harvested product such as, for example:
1) Transgenic plants which synthesize a modified starch which is altered with respect to its chemophysical traits, in particular the amylose content or the amylose/amylopectin ratio the degree of branching, the average chain length, the distribution of the side chains, the viscosity behavior, the gel resistance, the grain size and/or gain morphology of the starch in comparison to the synthesized starch in wild-type plant cells or plants, such that this modified starch is better suited for certain applications. These transgenic plants synthesizing a modified starch are described, for example, in EP 0571427, WO 1995/004826, EP 0719338, WO 1996/15248, WO 1996/19581, WO 1996/27674, WO 1997/11188, WO 1997/26362, WO 1997/32985, WO 1997/42328, WO 1997/44472, WO 1997/45545, WO 1998/27212, WO 1998/40503, WO 99/58688, WO 1999/58690, WO 1999/58654, WO 2000/008184, WO 2000/008185, WO 2000/28052, WO 2000/77229, WO 2001/12782, WO 2001/12826, WO 2002/101059, WO 2003/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 2000/22140, WO 2006/063862, WO 2006/072603, WO 2002/034923, EP 06090134.5, EP 06090228.5, EP 06090227.7, EP 07090007.1, EP 07090009.7, WO 2001/14569, WO 2002/79410, WO 2003/33540, WO 2004/078983, WO 2001/19975, WO 1995/26407, WO 1996/34968, WO 1998/20145, WO 1999/12950, WO 1999/66050, WO 1999/53072, U.S. Pat. No. 6,734,341, WO 2000/11192, WO 1998/22604, WO 1998/32326, WO 2001/98509, WO 2001/98509, WO 2005/002359, U.S. Pat. No. 5,824,790, U.S. Pat. No. 6,013,861, WO 1994/004693, WO 1994/009144, WO 1994/11520, WO 1995/35026 and WO 1997/20936.
2) transgenic plants which synthesize non-starch carbohydrate polymers or which synthesize non-starch carbohydrate polymers with altered properties in comparison to wild type plants without genetic modification. Examples are plants which produce polyfructose, especially of the inulin and levan type, as described in EP 0663956, WO 1996/001904, WO 1996/021023, WO 1998/039460 and WO 1999/024593, plants which produce alpha-1,4-glucans, as described in WO 1995/031553, US 2002/031826, U.S. Pat. No. 6,284,479, U.S. Pat. No. 5,712,107, WO 1997/047806, WO 1997/047807, WO 1997/047808 and WO 2000/14249, plants which produce alpha-1,6-branched alpha-1,4-glucans, as described in WO 2000/73422, and plants which produce alternan, as described in WO 2000/047727, EP 06077301.7, U.S. Pat. No. 5,908,975 and EP 0728213.
3) transgenic plants which produce hyaluronan, as described, for example, in WO 2006/032538, WO 2007/039314, WO 2007/039315, WO 2007/039316, JP 2006/304779 and WO 2005/012529.

Plants or plant varieties (obtained by plant biotechnology methods such as genetic engineering) which may also be treated according to the invention are plants, such as cotton plants, with altered fibre characteristics. Such plants can be obtained by genetic transformation, or by selection of plants containing a mutation imparting such altered fibre characteristics and include:
a) plants, such as cotton plants, which contain an altered form of cellulose synthase genes, as described in WO 1998/000549,
b) plants, such as cotton plants, which contain an altered form of rsw2 or rsw3 homologous nucleic acids, as described in WO 2004/053219;
c) plants, such as cotton plants, with an increased expression of sucrose phosphate synthase, as described in WO 2001/017333;
d) plants, such as cotton plants, with an increased expression of sucrose synthase, as described in WO 02/45485;
e) plants, such as cotton plants, wherein the timing of the plasmodesmatal gating at the basis of the fibre cell is altered, for example through downregulation of fibre-selective β-1,3-glucanase, as described in WO 2005/017157;
f) plants, such as cotton plants, which have fibres with altered reactivity, for example through the expression of the N-acetylglucosaminetransferase gene including nodC and chitin synthase genes, as described in WO 2006/136351.

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation or by selection of plants containing a mutation imparting such altered oil characteristics and include:
a) plants, such as oilseed rape plants, which produce oil having a high oleic acid content, as described, for example, in U.S. Pat. No. 5,969,169, U.S. Pat. No. 5,840,946 or U.S. Pat. No. 6,323,392 or U.S. Pat. No. 6,063,947;
b) plants, such as oilseed rape plants, which produce oil having a low linolenic acid content, as described in U.S. Pat. No. 6,270,828, U.S. Pat. No. 6,169,190 or U.S. Pat. No. 5,965,755.
c) plants, such as oilseed rape plants, which produce oil having a low level of saturated fatty acids, as described, for example, in U.S. Pat. No. 5,434,283.

Particularly useful transgenic plants which may be treated according to the invention are plants which comprise one or more genes which encode one or more toxins are the transgenic plants available under the following trade names: YIELD GARD® (for example maize, cotton, soya beans), KnockOut® (for example maize), BiteGard® (for example maize), BT-Xtra® (for example maize), StarLink® (for example maize), Bollgard® (cotton), Nucotn® (cotton), Nucotn 33B® (cotton), NatureGard® (for example maize), Protecta® and NewLeaf® (potato). Examples of herbicide-tolerant plants which may be mentioned are maize varieties, cotton varieties and soya bean varieties which are available under the following trade names: Roundup Ready® (tolerance to glyphosate, for example maize, cotton, soya beans), Liberty Link® (tolerance to phosphinothricin, for example oilseed rape), IMI® (tolerance to imidazolinone) and SCS® (tolerance to sulphonylurea, for example maize). Herbicide-resistant plants (plants bred in a conventional manner for herbicide tolerance) which may be mentioned include the varieties sold under the name Clearfield® (for example maize).

Particularly useful transgenic plants which may be treated according to the invention are plants containing transformation events, or a combination of transformation events, that are listed for example in the databases for various national or regional regulatory agencies (see for example http://gmoinfo.jrc.it/gmp_browse.aspx and http://www.agbios.com/dbase.php).

The combinations of flubendiamide and beneficial species are also suitable for controlling animal pests in the domestic field, in hygiene and in the protection of stored products, in particular insects, arachnids and mites, which are found in enclosed spaces such as, for example, dwellings, factory halls, offices, vehicle cabins and the like. They are active against sensitive and resistant species and against all developmental stages. These pests include:

From the order of the Scorpionidea, for example, Buthus occitanus. From the order of the Acarina, for example, Argas persicus, Argas reflexus, Bryobia spp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae. From the order of the Araneae, for example, Aviculariidae, Araneidae. From the order of the Opiliones, for example, Pseudoscorpiones chelifer, Pseudoscorpiones cheiridium, Opiliones phalangium. From the order of the Isopoda, for example, Oniscus asellus, Porcellio scaber. From the order of the Diplopoda, for example, Blaniulus guttulatus, Polydesmus spp. From the order of the Chilopoda, for example, Geophilus spp. From the order of the Zygentoma, for example, Ctenolepisma spp., Lepisma saccharina, Lepismodes inquilinus. From the order of the Blattaria, for example, Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa. From the order of the Saltatoria, for example, Acheta domesticus. From the order of the Dermaptera, for example, Forficula auricularia. From the order of the Isoptera, for example, Kalotermes spp., Reticulitermes spp. From the order of the Psocoptera, for example, Lepinatus spp., Liposcelis spp. From the order of the Coleoptera, for example, Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum. From the order of the Diptera, for example, Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa. From the order of the Lepidoptera, for example, Achroia grisella, Galleria mellonella, Plodia interpunctella, Tinea cloacella, Tinea pellionella, Tineola bisselliella. From the order of the Siphonaptera, for example, Ctenocephalides canis, Ctenocephalides felis, Pulex irritans, Tunga penetrans, Xenopsylla cheopis. From the order of the Hymenoptera, for example, Camponotus herculeanus, Lasius fuliginosus, Lasius niger, Lasius umbratus, Monomorium pharaonis, Paravespula spp., Tetramorium caespitum. From the order of the Anoplura, for example, Pediculus humanus capitis, Pediculus humanus corporis, Pemphigus spp., Phylloera vastatrix, Phthirus pubis. From the order of the Heteroptera, for example, Cimex hemipterus, Cimex lectularius, Rhodinus prolixus, Triatoma infestans.

Flubendiamide can be applied in aerosols, pressure-free spray products, for example pump and atomizer sprays, automatic fogging systems, foggers, foams, gels, evaporator products with evaporator tablets made of cellulose or plastic, liquid evaporators, gel and membrane evaporators, propeller-driven evaporators, energy-free, or passive, evaporation systems, moth papers, moth bags and moth gels, as granules or dusts, in baits for spreading or in bait stations.

Formulation examples for use in crop protection are given below, without the use of flubendiamide being limited to these formulations.
a) A dust is obtained by mixing 10 parts by weight of flubendiamide and 90 parts by weight of talc as inert substance and comminuting the mixture in a hammer mill.
b) A wettable powder which is readily dispersible in water is obtained by mixing 25 parts by weight of flubendiamide, 64 parts by weight of kaolin-containing quartz as inert substance, 10 parts by weight of potassium lignosulfonate and 1 part by weight of sodium oleoylmethyltaurinate as wetting agent and dispersant, and grinding the mixture in a pinned-disc mill.
c) A readily water-dispersible dispersion concentrate is obtained by mixing 20 parts by weight of flubendiamide with 6 parts by weight of alkylphenol polyglycol ether (®Triton X 207), 3 parts by weight of isotridecanol polyglycol ether (8 EO) and 71 parts by weight of paraffinic mineral oil (boiling range for example about 255 to above 277° C.) and grinding the mixture in a ball mill to a fineness of below 5 microns.
d) An emulsifiable concentrate is obtained from 15 parts by weight of flubendiamide, 75 parts by weight of cyclohexane as solvent and 10 parts by weight of oxyethylated nonylphenol as emulsifier.
e) Water-dispersible granules are obtained by mixing 75 parts by weight of flubendiamide, 10 parts by weight of calcium lignosulfonate, 5 parts by weight of sodium lauryl sulfate, 3 parts by weight of polyvinyl alcohol and 7 parts by weight of kaolin, grinding the mixture on a pinned-disc mill and granulating the powder in a fluidized bed by spraying on water as granulation liquid.
f) Water-dispersible granules are also obtained by homogenizing and precomminuting, in a colloid mill, 25 parts by weight of flubendiamide, 5 parts by weight of sodium 2,2′-dinaphthylmethane-6,6′-disulfonate, 2 parts by weight of sodium oleoylmethyltaurinate, 1 part by weight of polyvinyl alcohol, 17 parts by weight of calcium carbonate and 50 parts by weight of water, subsequently grinding the mixture in a bead mill and atomizing and drying the resulting suspension in a spray tower by means of a single-substance nozzle.

The good insecticidal and acaricidal action of the combinations according to the invention of flubendiamide and beneficial species can be seen from the examples which follow. While the individual active compounds or beneficial species show weaknesses in their action, the combinations show an action which exceeds a simple sum of actions.

A synergistic effect in insecticides and acaricides is always present when the action of the combinations of flubendiamide and beneficial species exceeds the total of the actions of the active compounds or beneficial species when applied individually.

The expected action for a given combination of two active compounds can be calculated as follows, using the formula of S. R. Colby, Weeds 15 (1967), 20-22:

### If

X is the kill rate, expressed as % of the untreated control, when employing active compound A at an application rate of m g/ha, m mg of ai/plant or in a concentration of m ppm,
Y is the kill rate, expressed as % of the untreated control, when employing the beneficial species at an application rate of n animals or n units, and
E is the kill rate, expressed as % of the untreated control, when employing active compound

A and beneficial species B at an application rate of m ppm, m mg of ai/plant or g/ha and n animals or units,

then

$$E = X + Y - \frac{X \cdot Y}{100}$$

If the actual insecticidal or acaricidal kill rate exceeds the calculated value, the kill of the combination is superadditive, i.e. a synergistic effect is present. In this case, the actually observed kill rate must exceed the value calculated using the above formula for the expected kill rate (E).

The invention is illustrated in more detail by the examples below, without being limited thereby.

### EXAMPLE A

Myzus persicae test (drench application)

| | |
|---|---|
| Solvent: | 7 parts by weight of dimethylformamide |
| Emulsifier: | 2 parts by weight of alkylaryl polyglycol ether |

To produce a suitable preparation of active compound, 1 part by weight of active compound is mixed with the stated amounts of solvent and emulsifier, and the concentrate is diluted with emulsifier-containing water to the desired concentration.

Cabbage plants (Brassica oleracea) which are heavily infested by the green peach aphid (Myzus persicae) are treated by watering with the active compound preparation of the desired concentration.

After the application, the predatory bugs (Macrolophus caliginosus) are added in a defined amount. After the desired period of time, the kill of the pest in % is determined 100% means that all of the aphids have been destroyed; 0% means that none of the aphids have been destroyed.

The kill rates determined are entered into Colby's formula (see above).

In this test, the following combination of flubendiamide and predatory bugs shows a synergistically enhanced activity compared to the components appied individually; however, the patent application is not limited to this combination.

TABLE A
Myzus persicae test

| | Concentration | Number of | Kill | |
|---|---|---|---|---|
| Active compound | in mg of ai/l soil | animals | in % after 4^{h} | |
| flubendiamide | 1 | | 45 | |
| Macrolophus | | 10 | 0 | |
| caliginosus | | | | |
| | | | found* | calc.** |
| flubendiamide + | 1 | 10 | 65 | 45 |
| Macrolophus | | | | |
| caliginosus | | | | |
| according to | | | | |
| the invention | | | | |

*found = activity found
**calc. = activity calculated using Colby's formula

### EXAMPLE B

Plutella xylostella test (drench application on rock wool)

| | |
|---|---|
| Solvent: | 7 parts by weight of dimethylformamide |
| Emulsifier: | 2 parts by weight of alkylaryl polyglycol ether |

To produce a suitable preparation of active compound, 1 part by weight of active compound is mixed with the stated amounts of solvent and emulsifier, and the concentrate is diluted with water to the desired concentration.

Cabbage plants (Brassica oleracea) are watered with an active compound preparation of the desired concentration and infected with larvae of the diamondback moth (Plutella xylostella).

After the desired period of time, the kill of the pest in % is determined 100% means that all caterpillars have been killed; 0% means that none of the caterpillars have been killed. In this test, flubendiamide, applied to soil-less substrates, shows surprisingly good systemic efficacy.

TABLE B
Plutella xylostella - test on rock wooll

| | Concentration in | Kill in % |
|---|---|---|
| Active compound | mg of ai/plant | after 7^{d} |
| flubendiamide on rock | 1 | 97 |
| wool | | |
| according to the invention | | |
| flubendiamide on sandy | 1 | 40 |
| loam | | |
| prior art | | |

We claim:

1. A composition comprising flubendiamide and at least one beneficial species selected from the group consisting of predatory mites, nematodes, fungi, bacteria, virus strains, Araneae, Acari, Dermaptera, Hymenoptera, Coleoptera, Neuroptera, Thysanoptera, Heteroptera, Diptera, Hemiptera, Dermaptera Parasitiformes, and Plannipennia.

2. The composition according to claim 1, wherein the at least one beneficial species is selected from the group consisting of predatory mites, nematodes, Heteroptera, Plannipennia, Hymenoptera, Coleoptera, and Diptera.

3-10. (canceled)

11. A method for controlling animal pests comprising applying to a plant growing in a cultivation substrate flubendiamide and at least one beneficial species selected from the group consisting of predatory mites, nematodes, fungi, bacteria, viruses, Araneae, Acari, Dermaptera, Hymenoptera, Coleoptera, Neuroptera, Thysanoptera, Heteroptera, Diptera, Hemiptera, Dermaptera, Parasitiformes, and Plannipennia.

12. The method according to claim 11 wherein the at least one beneficial species is selected from the group consisting of predatory mites, nematodes, Heteroptera, Plannipennia, Hymenoptera, Coleoptera and Diptera.

13. The method according to claim 11 wherein the cultivation substrate is a soil-less substrate.

14. The method according to claim 11 wherein the cultivation substrate is soil.

15. The method according to claim 11 wherein the plant is an annual or perennial crop plant.

16. The method according to claim 11 wherein the plant is selected from the group consisting of cotton, pone fruit, stone fruit, nuts, maize, rice, and soya beans.

17. The method according to claim 13 wherein the soil-less substrate is selected from the group consisting of peat mosses, coconut fibres, rock wool, pumice, expanded clay, clay granules, expanded plastic, vermiculities, perlites, artificial soil and combinations thereof.

18. The method according to claim 11 wherein flubendiamide and the at least one beneficial species are applied at different times.

19. The method according to claim 11 wherein flubendiamide is applied to the cultivation substrate.

20. The method according to claim 11 wherein flubendiamide is applied to the plant.

21. The method according to claim 11 wherein the at least one beneficial species is applied to the plant.

22. The method according to claim 11 wherein the at least one beneficial species is applied to the cultivation substrate.

23. The method according to claim 14 wherein the crop plant is an annual crop plant.

24. The method according to claim 14 wherein the crop plant is a perennial crop plant.

25. The method according to claim 11 wherein flubendiamide is applied in a greenhouse.

26. The method according to claim 11 wherein the at least one beneficial species is applied in a greenhouse.

27. The method according to claim 11 wherein flubendiamide and the at least one beneficial species provide a synergistically enhanced activity against animal pests compared to flubendiamide being applied individually and/or compared to the at least one beneficial species being applied individually for the control of the animal pests.
